(19) United States
(12) Patent Application Publication
(10) Pub. No.: US 2004/0205503 A1
(43) Pub. Date: Oct. 14, 2004

(54) Adaptive web pages

(76) Inventor: Srinivas Gutta, Buchanan, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/004,472

(22) Filed: Nov. 2, 2001

(51) Int. Cl. G06F 17/30; G06F 17/00

(52) U.S. Cl. 715/501.1; 707/3; 345/760

(57) ABSTRACT

The present invention relates to a method and system for updating web page access. Initially, a hit list containing a plurality of hypertext links in response to a user's search request is generated. The user begins selecting one of the hypertext links to access a corresponding website and other links that may be available in the selected website. A history of hypertext links that the user accessed is monitored, and upon W backtracking to the page containing the hit list for further search, the hit list is updated by removing the hypertext links that are previously accessed by the user. The hit list also may be updated according to predetermined criteria.

### BACKGROUND OF THE INVENTION

1. Field of the Invention

The present invention relates to hypertext link systems and, more particularly, to a system and method for updating website access, so that a user can avoid revisiting a previously accessed website.

2. Description of the Related Art

The Internet has become a most widely used tool for researching and educating the public. This is achieved using a software program known as a “browser.” Using the World Wide Web, a user is given access to unlimited information. The browser is a graphic user interface that enables users to navigate various sites on the Internet.

Typically, a user begins a search by selecting a first hypertext link and thereafter may decide to navigate through other hypertext links connected from the first link. A hypertext link contains the name and uniform resource locator (URL) address of other Internet sites, such that if a user clicks on a hypertext link, the browser leads the user to the selected hypertext link. If the user has finished navigating from the first hypertext link, the user normally returns to the original page containing a number of hypertext links (hereafter referred to as “hit list”). Thereafter, the user may decide to select a next hypertext link to search more information. However, the successive links of the hit list often may contain information from the links that have been previously visited by the user.

Often the user realizes this after navigating for some length of time in the previously visited site because the hit list fails to indicate that the user has already visited the link. Thus, the user wastes time visiting the link that he or she has already traversed. Accordingly, there is a need for an interface browser that prevents the user from revisiting the same sites during a search mode.

### SUMMARY OF THE INVENTION

The present invention relates to a system and method for displaying updated hypertext links by removing the links that have been previously visited by the user, so that the user can avoid revisiting the same sites in a subsequent searching mode.

An aspect of the present invention provides a method for updating web page access. The method includes the steps of generating a hit list with a plurality of hypertext links in response to a search request made by a user; allowing the user to access a corresponding website connected to the hypertext links; identifying at least one of said hypertext links accessed by the user; updating the hit list by removing the hypertext links that are previously accessed by the user; and, displaying the updated list to the user for further search. The hypertext links comprise clickable image links and include an associated universal resource locator (URL) address. The updated hit list may be rearranged according to predetermined criteria.

Another aspect of the present invention provides a method for updating web page access which includes the steps of: receiving a search request from a user; generating a hit list with a plurality of hypertext links associated with the search request; opening and displaying a corresponding website when one of said hypertext links is selected by the user; monitoring at least one of said hypertext links that the user visits during a search mode; removing the hypertext link that has been visited by the user from said hit list; and, reproducing a new hit list based on the outcome of the removing step and according to predetermined criteria.

Another aspect of the invention provides a system for updating web page access. The system includes a means for generating a hit list containing a plurality of hypertext links in response to a search request made by a user; a means for allowing the user to access a corresponding website from at least one of the hypertext links selected by the user; a means for identifying at least one of the hypertext links accessed by the user; and, a means for updating said hit list by removing the hypertext links that are previously accessed by the user. The system further includes a means for returning the user to the hit list after accessing the corresponding website, and a means for opening and displaying other cross-links provided in the corresponding website. The hit list may be further rearranged according to predetermined criteria.

### BRIEF DESCRIPTION OF THE DRAWINGS

A more complete understanding of the method and apparatus of the present invention is available by reference to the following detailed description when taken in conjunction with the accompanying drawings wherein:

FIG. 1 is a simplified diagram illustrating a computer work station whereto embodiments of the present invention are to be applied;

FIG. 2 illustrates a simplified circuit diagram of the computer work station according to an embodiment of the present invention;

FIG. 3 is a flow chart providing an overview of the method according to an embodiment of the present invention;

FIG. 4 is a window display of the browser in accordance with the present invention;

FIG. 5 is a window display of the browser in accordance with the present invention; and,

FIG. 6 is a diagram providing the hypertext link information of the window display shown in FIG. 4 in accordance with the present invention.

### DETAILED DESCRIPTION OF THE EMBODIMENTS

In the following description, for purposes of explanation rather than limitation, specific details are set forth such as the particular architecture, interfaces, techniques, etc., in order to provide a thorough understanding of the present invention. For purposes of simplicity and clarity, detailed descriptions of well-known devices, circuits, and methods are omitted so as not to obscure the description of the present invention with unnecessary detail.

FIG. 1 is a diagram of the computer system according to an embodiment of the present invention. It shows a computer system having user input devices, keyboard 2 and mouse 4, connected to the Internet 8 via a server 6. While the computer system 10 of FIG. 1 is a general purpose computer, it will be appreciated that custom hardware also can be employed for implementing the disclosed invention. The computer system 10 may be connected via communication links to another computer or a mainframe system to which other terminals are connected. Hence, using the browser implemented in the computer system 10, access to a number of websites via an Internet link is achieved. The accessed document is shown in the form of an HTML document. It should be noted that any number of commercially or publicly available browsers can be utilized in various implementations in accordance with the preferred embodiment of the present invention.

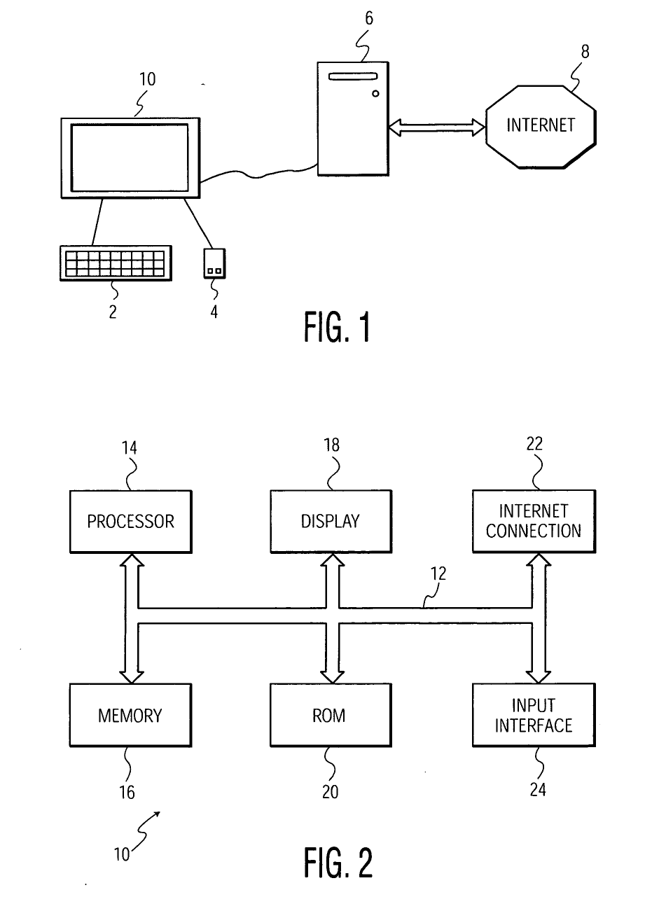

FIG. 2 illustrates an exemplary embodiment of the present invention which comprises a computer system or work station having at least a processor, random access memory, and a bus that are running on the operating system. In particular, the computer system 10 comprises a bus 12 or other communication means for communicating information; a processor 14 or other processing means coupled to the bus 12 for processing it information; a memory 16 or dynamic storage means for storing instructions and information to be executed by the processor 14 as well as other intermediate information generated during the execution of instructions by the processor 14; a display 18 for displaying information processed by the processor 14; a read-only-memory (ROM) 20 for storing static information and instructions for the processor 14; an Internet connection 22 for connecting to the Internet network; and, an input interface 24 for inputting information entered by the user. An operating system resident in memory 16 and executed by the processor 14 coordinates the operation of the other elements of the system 10. In particular, the operating system controls the allocation of system resources and performs tasks, such as processing, scheduling, memory management, networking, and I/O services, among other things. Although the description may refer to terms commonly used in describing particular computer systems, the description and the concepts equally apply to other processing systems, including systems having architecture dissimilar to that shown in FIG. 2. Furthermore, it should be noted that the computer system 10 within the context of this disclosure includes a laptop computer, a mobile phone, and other mobile computer devices, such as a personal digital assistant (PDA), a personal communication assistant (PCA), an electronic organizer, an interactive TV/set-top box remote control, or any duplex interactive devices with the capability to access the Internet.

In operation, the web browser directs the processor 14 to search and download information from various websites, then displays the information to the user via the display 18. In the search mode, the user typically inputs a number of queries via the input interface 24 to access information from the Internet. Inputting queries using a pointing device (i.e., keyboard 2 and mouse 4) is well known in the computer art and need not be further described. The browser generates a hit list containing the number of hypertext links related to the requested subject and stores it in the memory 16. Thereafter, the user begins selecting a first hypertext link and navigates information associated with the first hypertext link. The user may decide to navigate other hypertext links extending from the first hypertext link. If the user has finished navigating the path from the first hypertext link, the user returns to the original page containing the hit list to select another hypertext link for further search. To this end, the user normally backtracks through the links to the original page, whereupon the user can select a second hypertext link. At the same time, the processor 14 updates the hit list by deleting the address of the first hypertext link, or other cross links traversed by the user from the hit list, so that the hit list does not contain any hypertext link address that the user has already visited. Accordingly, the user can avoid revisiting the previously accessed links, thus saving time in the subsequent search mode.

The chosen embodiment of the present invention is a computer software executed within the computer system 10. Computer programs (or computer control logic) are stored in the memory 16. Such computer programs, when executed, enable the computer system 10 to perform the function of the present invention as discussed herein.

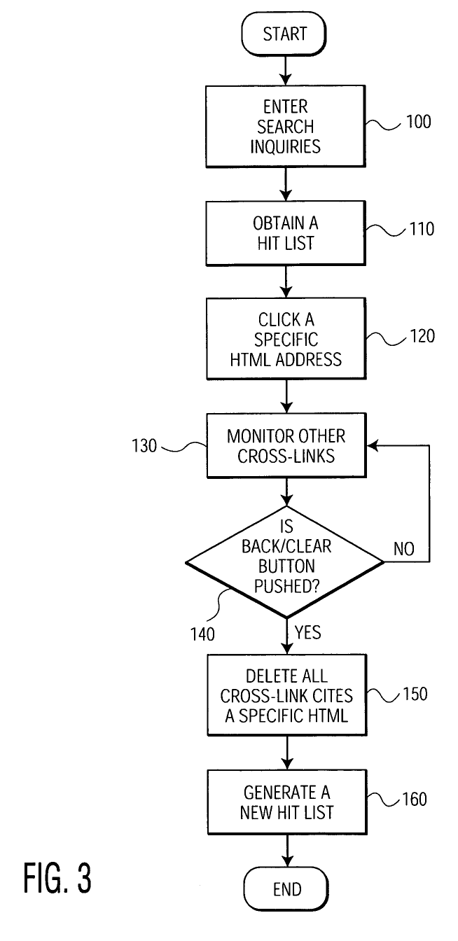

FIG. 3 is a flow chart illustrating the operation steps incorporated in the web browsing software in accordance with the present invention in greater detail. The rectangular elements indicate computer software instructions, whereas the diamond-shaped element represents computer software instructions that affect the execution of the computer software instructions represented by the rectangular blocks.

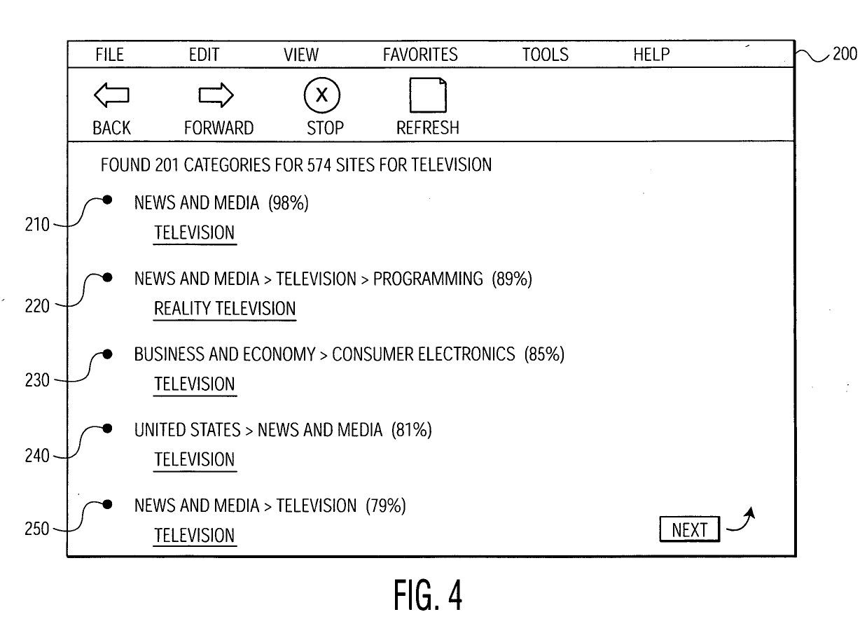

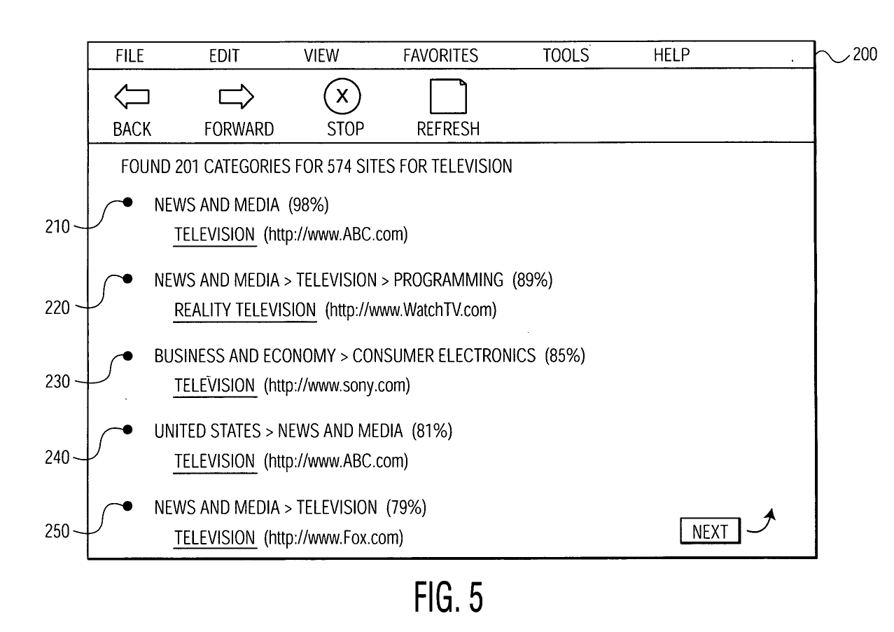

In step 100, the user enters a number of key words to conduct search from the Internet. In step 110, the browser compiles a list of related link sources and generates a hit list, as shown in FIG. 4. The list of hypertext links shown in the window 200 is temporarily saved in the memory 16 for subsequent retrieval. As shown in FIG. 4, the window 200 displays the first set of search results containing the search key word “television” according to the percentage of hits associated with the key words in search. In step 120, the user begins selecting the first item to navigate a particular web address by clicking the text representing the link 210. FIG. 5 illustrates the corresponding web address of the search results that is shown in the hit list for illustrative purposes. When the user selects the link 210, the browser enters the URL: http//www.ABC.com website to download information and displays the retrieved information on the computer monitor. If the downloaded page includes links to other websites, the browser keeps track of those links that the user visits in step 130.

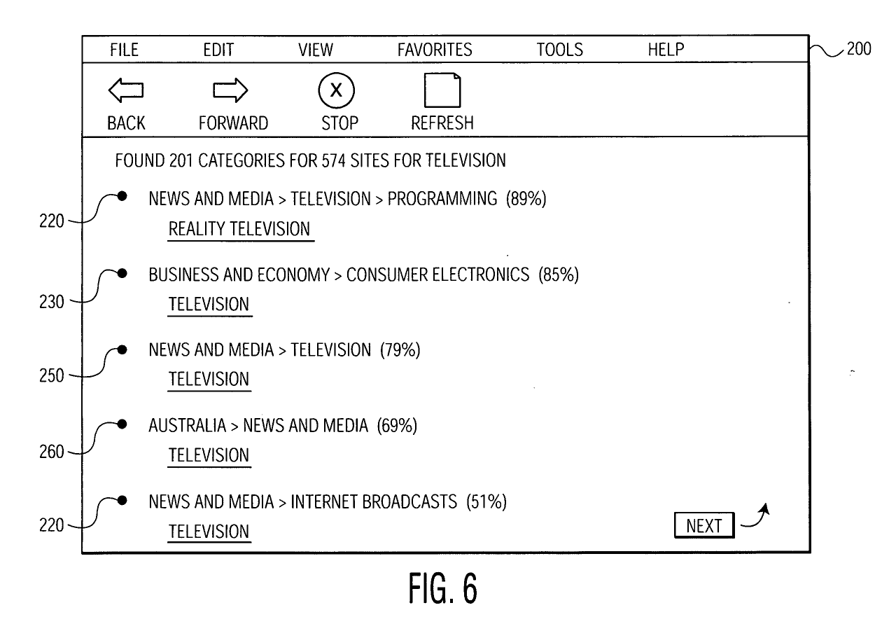

Thereafter, it is determined whether the user decides to return to the hit list page for further search in step 140. Typically, the user must backtrack to the hit list page by clicking the “Back” button. Alternatively, some browser may allow the user to save time in returning to the hit list without backtracking by merely pushing a button, i.e., the “Refresh” or “Clear” button. If such a button or backtracking is performed in step 140, the browser determines which websites have been visited by the user, then removes the previously visited sites from the hit list in step 150. Finally, in step 160, the browser generates a new hit list, as shown in FIG. 6, without the repeated links that have been previously visited by the user, including other cross-links that are visited by the user. That is, the browser deletes the URL and name of the document that have been accessed by the user. For example, as the user has already visited the link 210 and the web address of the link 240 is the same as the link 210, both the link 210 and the link 240 will not be shown in the subsequently generated hit list, as shown in FIG. 6. In addition, when generating the new list, the browser can be implemented so that the new hit list may contain only the successive hypertext links with a certain percentage of hits. For example, the new hit list may not include links with less than 50 percent of the hit rate, as shown in FIG. 6.

The various steps described hereinabove may be implemented by programming them into functions incorporated within application programs, and programmers of ordinary skill in the field can implement them using customary programming techniques in languages, such as C, Visual Basic, Java, Perl, C++, and the like.

As is apparent from the foregoing, the present invention provides a mechanism to avoid navigating repeated link data and graphic text data items that are previously visited by the user during each search session, thus avoiding the time and the overhead associated with presenting the items at more than one time.

While the preferred embodiments of the present invention have been illustrated and described, it will be understood by those skilled in the art that various changes and modifications may be made, and equivalents may be substituted for elements thereof, without departing from the true scope of the present invention. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention include all embodiments falling within the scope of the appended claims.

What is claimed is:

1. A method for updating web page access, the method comprising the steps of:
(a) generating a hit list having a plurality of hypertext links in response to a search request made by a user;
(b) allowing said user to access a corresponding website connected to at least one of said hypertext links;
(c) identifying said hypertext links accessed by said user; and,
(d) updating said hit list by removing said identified hypertext links from said hit list.

2. The method of claim 1, further comprising the step of displaying said updated hit list to said user for a subsequent search.

3. The method of claim 1, wherein said step (b) comprises the step of returning said user to said hit list after accessing the corresponding website.

4. The method of claim 3, further comprising the steps of repeating said steps (b) through (d).

5. The method of claim 1, wherein said step (b) comprises the step of accessing other cross-links provided in said accessed website.

6. The method of claim 1, further comprising the step of rearranging said updated hit list according to predetermined criteria.

7. The method of claim 1, wherein said hypertext links comprise clickable image links.

8. The method of claim 1, wherein said hypertext links include an associated universal resource locator (URL) address.

9. The method of claim 1, wherein said step (b) comprises the step of displaying the corresponding website from at least one of said hypertext links selected by said user.

10. A method for updating web page access, the method comprising the steps of:
(a) receiving a search request from a user;
(b) generating a hit list having a plurality of hypertext links associated with said search request;
(c) monitoring at least one of said hypertext links that said user visits during a search mode;
(d) removing said monitored link that has been visited by said user from said hit list; and,
(e) reproducing a new hit list based on the outcome of said removing step (d).

11. The method of claim 10, wherein said step (c) comprises the step of opening and displaying a corresponding website connected to one of said hypertext links selected by said user.

12. The method of claim 11, further comprising the steps of opening and displaying other cross-links provided in said accessed website.

13. The method of claim 10, wherein said hypertext links comprise clickable image links.

14. The method of claim 10, wherein said hypertext links include an associated universal resource locator (URL) address.

15. The method of claim 10, further comprising the step of rearranging said new hit list according to predetermined criteria.

16. The method of claim 10, further comprising the step of presenting said new hit list to said user.

17. A system for updating web page access comprising:
means for generating a hit list having a plurality of hypertext links in response to a search request made by a user;
means for allowing said user to access a corresponding website connected to at least one of said hypertext links selected by said user;
means for identifying said hypertext links accessed by said user; and,
means for updating said hit list by removing said identified hypertext links that are previously accessed by said user from said hit list.

18. The system of claim 17, further comprising a means for returning said user to said hit list after accessing the corresponding website.

19. The system of claim 18, further comprising a means for opening and displaying other cross-links provided in said accessed website.

20. The system of claim 17, wherein said hypertext links comprise clickable image links.

21. The system of claim 17, wherein said hypertext links include an associated universal resource locator (URL) address.

22. The system of claim 17, further comprising a means for rearranging said updated hit list according to predetermined criteria.

23. The system of claim 17, further comprising a means for presenting said updated hit list to said user.

24. A system for updating web page access comprising:
a memory for storing a computer-readable code; and,
a processor operatively coupled to said memory, said processor configured to:
receive a search request from a user;
generate a hit list having a plurality of hypertext links associated with said search request;
monitor at least one of said hypertext links that said user visits during a search mode; and,
updating said hit list by removing said monitored link that has been visited by said user from said hit list.

25. The system of claim 24, further comprising a means for opening and displaying a corresponding website connected to at least one of said hypertext links selected by said user.

26. The method of claim 25, further comprising a means for opening and displaying other cross-links provided in the corresponding website.

27. The system of claim 24, wherein said hypertext links comprise clickable image links.

28. The system of claim 24, wherein said hypertext links include an associated universal resource locator (URL) address.

29. The system of claim 24, wherein said updated hit list is rearranged according to predetermined criteria.
